(19) United States
(12) Patent Application Publication
(10) Pub. No.: US 2010/0117563 A1
(43) Pub. Date: May 13, 2010

(54) Electronic Operating Device and Method for the Incremental Dimming of a Lighting Device

(76) Inventor: Michael Hani, Bad Albling (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/525,067

(22) PCT Filed: Jan. 29, 2007
(86) PCT No.: PCT/EP2007/050837

§ 371 Date: Jul. 29, 2009

(51) Int. Cl. H05B 37/00

(52) U.S. Cl. 315/320

(57) ABSTRACT

An electronic operating device for the incremental dimming of one or more luminous means, comprising two or more switching inputs, which can be current-carrying or non-current-carrying, wherein the operating device dims the luminous means to different light levels owing to the switching combination of the switching inputs.

### TECHNICAL FIELD

The invention relates to electronic operating devices for luminous means which are suitable for dimming these luminous means.

### PRIOR ART

There is a wide variety of possible solutions for dimming luminous means. Firstly, for relatively large lighting systems there has long being an analog interface which reflects the respective dimming state via an analog voltage of from 1 to 10 V. Secondly, there is a relatively new digital interface which can be used to resolve a wide variety of complex lighting tasks. Both methods have the disadvantage in common that control devices are needed for this purpose which are then used to drive the electronic operating device.

For relatively simple installations, for example in the domestic sector, there are relatively simple methods which are aimed at controlling the operating device autonomously with only one on/off switch. In this case, the so-called touch-dim method could be mentioned by way of example which is now widely used. In this case, the electronic operating devices are permantly connected to the system voltage and are switched on and off via a control input. A momentary-contact switch is used for this purpose. If, after switching-on, the momentary-contact switch is actuated in a specific way, for example is held depressed for a relatively long period of time, the electronic operating device dims down the luminous means over a predefined range and then dims said luminous means up again etc. As soon as the momentary-contact switch is released again, the present dimming position is retained. These devices have the disadvantage, however, that they are permanently connected to the power supply system and therefore result in standby losses which should not be underestimated.

A further known dimming method is the single-switch dimming. The dimming function is in this case started by means of the light switch by the switching operation “on-off-on”. If the desired dimming value has been reached, this dimming value is stored by “off”. When the light is next switched on, the stored dimming value is automatically set again.

A further method is the so-called three-stage dimming, which has primarily found widespread use in the NAFTA sector. In this case, two electronic operating devices are used in one luminaire. Generally, the first operating device operates one luminous means, and the second operating device operates two luminous means. The luminous means all have the same power. The luminaire is driven by two phases. Depending on which phase is connected, three dimming levels can be realized; in this case the operating devices are driven either individually or jointly. If only the first operating device is operated, one luminous means illuminates. If only the second operating device is operated, two luminous means illuminate. If both are operated, all three luminous means illuminate. Thus, three “dimming levels” can be realized, in the present example with approximately 33%, 66% and 100% in the case of luminous means with the same power. Since two operating devices are used, this variant is very cost-intensive,

also because the installation complexity in the luminaire is considerable.

### Object

The object of the invention is therefore to improve the known method of three-level dimming and to design it such that it is more cost-effective. This object is achieved by an electronic operating device having the features of claim 1 and a method having the features of claim 7.

### DESCRIPTION OF THE INVENTION

The invention proposes an electronic operating device which, in addition to the known inputs for phase (L1), neutral (N) and ground (PE), also has a second input for a further phase. The two phase inputs (L_{S1}, L_{S2}) are interconnected internally in the electronic operating device in such a way that different dimming levels can be realized depending on the driving of the two inputs. The phase inputs are also designed to be operated with direct current, and the electronic operating device is therefore also suitable for emergency power supply systems.

### BRIEF DESCRIPTION OF THE DRAWING(S)

FIG. 1 shows a schematic circuit diagram of a lighting system with single-lamp operating devices and two switching inputs.

FIG. 2 shows a schematic circuit diagram of a lighting system with two-lamp operating devices and three switching inputs.

FIG. 3 shows a schematic circuit diagram of a lighting system with two-lamp operating devices and two switching inputs, the operating devices having a fixed current terminal and the switching inputs therefore being capable of being switched without any power.

FIG. 4 shows a schematic circuit diagram of a lighting system with two-lamp operating devices and two switching inputs, the operating devices having a fixed current terminal and the switching inputs being capable of being switched independently.

### PREFERRED EMBODIMENT OF THE INVENTION

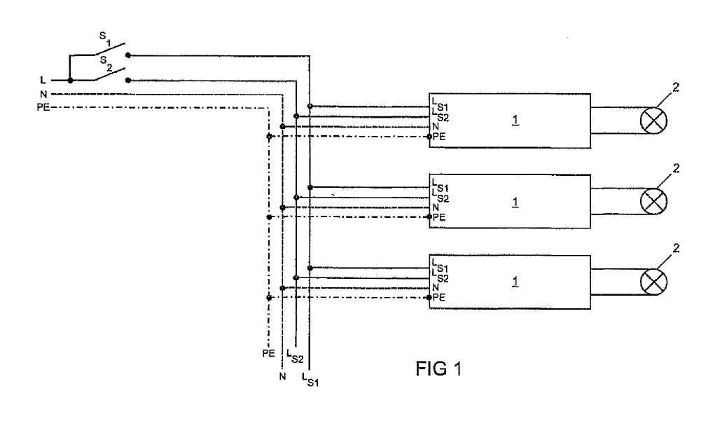

FIG. 1 shows a schematic circuit diagram with electronic operating devices in accordance with a first embodiment of the invention. The operating devices are designed for in each case one luminous means. This may be, for example, a fluorescent lamp, but a halogen lamp or a high-pressure discharge lamp is also conceivable. However, the invention can likewise be used for light modules comprising LEDs. The electronic operating devices each have two switching inputs L_{S1} and L_{S2}. It is possible to use the two switching inputs to realize two-level and three-level dimming.

The dimming table for the two-level dimming is as follows:

| | | Luminous means |
|---|---|---|
| Switching input Lₛ₁ | Switching input Lₛ₂ | dimming level |
| Off | Off | Off |
| On | Off | Light value 1 |
| | | (e.g. 50% light) |
| Off | On | Light value 1 |
| | | (e.g. 50% light) |
| On | On | Light value 2 |
| | | (e.g. 100% light) |

If only in each case one switching input is current-carrying, the luminous means is dimmed by the electronic operating device with a first light value. Depending on the embodiment, this light value may be freely settable or permanently programmed. If both switching inputs are switched so as to carry current, the electronic operating device dims the luminous means to a second light value. This light value may likewise be freely settable or permanently programmed (for example 100%).

However, three-level dimming is also possible with this circuit configuration. The dimming table for this purpose is as follows:

| | | Luminous means |
|---|---|---|
| Switching input Lₛ₁ | Switching input Lₛ₂ | dimming level |
| Off | Off | Off |
| On | Off | Light value 1 |
| | | (e.g. 25% light) |
| On | On | Light value 3 |
| | | (e.g. 50% light) |
| Off | On | Light value 2 |
| | | (e.g. 100% light) |

This embodiment has the advantage that, in order to change the light value, it is not necessary for a switching input to be switched on simultaneously while the other switching input is switched off. The problem of the current being interrupted during switchover is thereby circumvented.

However, the dimming table can also be as follows:

| | | Luminous means |
|---|---|---|
| Switching input Lₛ₁ | Switching input Lₛ₂ | dimming level |
| Off | Off | Off |
| On | Off | Light value 1 |
| | | (e.g. 25% light) |
| On | On | Light value 3 |
| | | (e.g. 50% light) |
| Off | On | Light value 2 |
| | | (e.g. 100% light) |

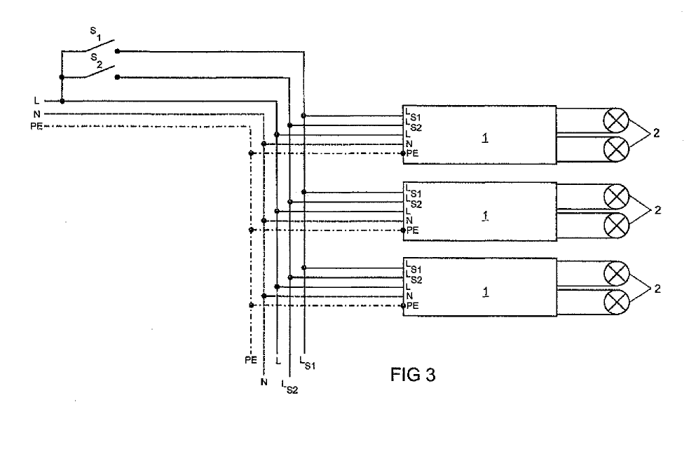

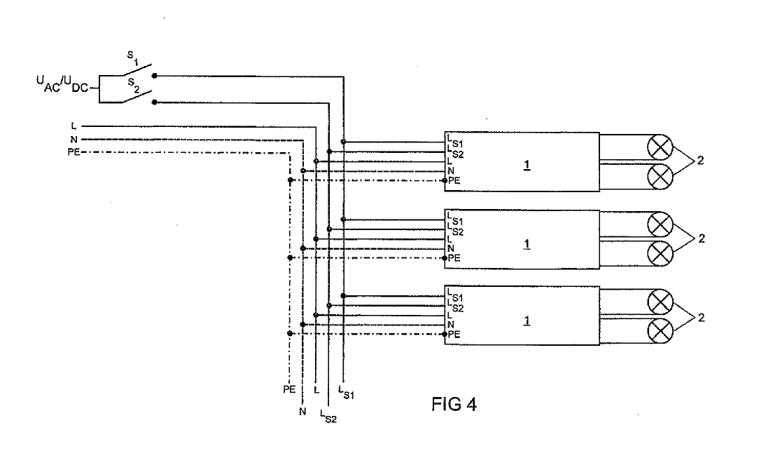

This table can primarily be applied to devices which are switched without any power, i.e. are permanently connected to the power supply (see FIGS. 3 and 4).

In the case of three-level dimming, there is also a third light value since a distinction is drawn between the two switching inputs. If switching input 1 is current-carrying and switching input 2 is not, a different dimming value is set than if switching input 2 is current-carrying a switching input 1 is not.

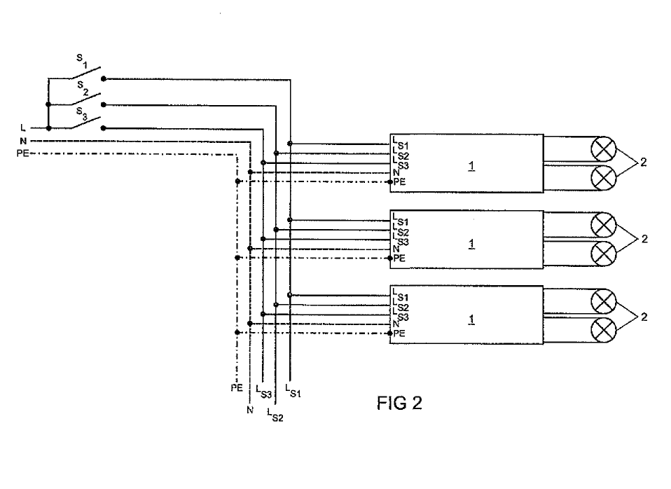

FIG. 2 shows a further embodiment of operating devices according to the invention. In this case, two-lamp operation devices are used which have three switching inputs. With three switching inputs it is possible to realized seven dimming levels, a value which in practice should be sufficient for virtually any application. In this case, it is also possible to save in terms of installation, and, instead of an AC cable, for example, a likewise conventional three-phase current cable can be used which provides lines for three phases.

Finally, FIG. 3 shows a variant with two-lamp operating devices and two switching inputs, the operating devices having a permanent current terminal and the switching inputs therefore being capable of being switched without any power. This has the advantage that the switching lines do not need to transmit any power, and the operating device is supplied permanently with current, with the result that it is also possible for specific functions to be realized when the luminous means are switched off. The disadvantage with this embodiment is a certain level of current consumption in the standby mode, i.e. when the luminous means are switched off.

FIG. 4 shows another variant of FIG. 3, in which the control devices which operate the switching inputs do not need to be connected to the same power supply system as the operating devices themselves. The switching inputs can also be switched with DC voltage or a predetermined signal shape, with the result that the control possibilities are extended.

### First Embodiment

This embodiment relates to a switching arrangement as shown in FIG. 1 or 2. With this method it is possible using the simplest means for both small and large lighting systems to be lit and dimmed in an inexpensive manner. It would be conceivable, for example, to use operating devices with two-level dimming in large buildings and to connect one input to a basic on/off switch and to connect the other input via a motion sensor. Thus, it is possible to realize a permanent required minimum lighting which is very energy-saving owing to the dimmed operating mode of the luminous means. As long as no one stays in the area being monitored, only one input is current-carrying, and the electronic operating device is therefore set to a low energy-saving dimming value. If a person enters the corresponding area, the motion sensor switches the second input on and the lighting in this area is switched to 100% light power. Thus, a person can move safely within a building without the entire movement area always needing to be fully illuminated. At night, the permanent phase can be disconnected, with the result that the devices do not have any standby losses, but nevertheless security lighting is provided by the motion sensor. If someone moves in the sensor range of the motion sensor, the luminous means are switched on.

### Second Embodiment

This embodiment relates to a circuit arrangement as shown in FIG. 1 or 2. The three-stage dimming may be of interest, for example, for business lighting systems. In this case, the business premises can be illuminated fully during business hours. Once the business has closed in the evening, but passers by doing “window shopping” are still to be expected, the areas can be dimmed to a lower light level which indicates that the business has closed but still allows the goods on show in the areas to be clearly visible. Finally, in the late evening, the lighting can be dimmed to an even lower energy-saving value, but this value can be set to be sufficiently bright for any burglars to still be clearly visible

### Further Features of the Invention

The concept can naturally also be extended. Theoretically, operating devices with even more switching inputs can also be used, in which case 2ⁿ-1 dimming levels would be possible.

Provision may be made for the light levels to be programmed permanently into the electronic operating device.

However, provision may also be made for the light levels to which the luminous means are dimmed owing to the switching combination of the inputs to be capable of being freely set. This can take place via a plurality of methods:

It is possible for the single-switch dimming method mentioned at the outset to be used in order to program the respective light levels. In this case, the associated switches can be used for the respective light levels; both switches therefore need to be actuated simultaneously in the case of the light level with two switched-on inputs. Then, for example, the light value 1 can be programmed merely via the input L_{S1}, the light value 2 can be programmed merely via the input L_{S2}, and the light value 3 can be programmed via both inputs L_{S1} and L_{S2} at the same time.

In order to prevent erroneous programming during normal operation, the single-switch dimming method can be extended such that the programming is only activated in the event of a switching sequence on-off-on-off-on. The automatic dimming is thereby started and the dimming value is stored by the switch being switched off again.

Alternatively, rotary regulators, for example trimmers or potentiometers, via which the respective light levels can be fed, can also be provided on the housing. However, it is also possible for stepping switches, for example DIP switches, to be used in order to be able to choose from a plurality of dimming levels.

However, it is also possible for an interface to be provided to which an external programming device can be connected in order to program the different light levels. In this case, various data transmission modes are conceivable:
The operating device can also have an infrared reception module, via which the different dimming levels can be programmed into the operating device.
A further possibility is for the operating device to have a reception module for electromagnetic radiation and for the dimming levels to be programmed via the reception of a specific signal sequence.
Finally, it is also conceivable for the operating device to have a module for extracting a signal sequence at the switching inputs L_{S1 or L}_{S2} or the terminal L. This signal sequence is modulated onto the lines and processed by the operating device in order to program the dimming levels.

1. An electronic operating device for the incremental dimming of one or more luminous means, comprising two or more switching inputs, which can be current-carrying or non-current-carrying, wherein the operating device dims the luminous means to different light levels owing to the switching combination of the switching inputs.

2. The electronic operating device as claimed in claim 1, wherein the light levels which are set owing to the switching combination of the inputs cannot be altered.

3. The electronic operating device as claimed in claim 1, wherein the light levels which are set owing to the switching combination of the inputs are freely selectable.

4. The electronic operating device as claimed in claim 3, wherein the freely selectable light levels can be set via rotary regulators or multistep switches or a plurality of switches on the operating device.

5. The electronic operating device as claimed in claim 3, wherein the freely selectable light levels can be programmed via a single-switch dimming method, the respecting switching combinations of the switching inputs being configured for programming the respective dimming levels.

6. The electronic operating device as claimed in claim 3, wherein the freely selectable light levels are adapted to be programmed via an external programming device.

7. The electronic operating device as claimed in claim 5, wherein the freely selectable light levels are adapted to be programmed via an infrared reception module integrated in the operating device.

8. The electronic operating device as claimed in claim 5, wherein the freely selectable light levels are adapted to be programmed via a reception module for electromagnetic radiation which is integrated in the operating device.

9. The electronic operating device as claimed in claim 5, wherein the freely selectable light levels are adapted be programmed via a signal sequence which is modulated onto the lines of the switching inputs or of the current terminal.

10. A method for operating one or more luminous means, comprising the steps of:
providing at least two switches for controlling the respective luminous means;
evaluating the switch positions by an electronic operating device; and
setting a predetermined light value for the respective luminous means by the electronic operating device on the basis of the evaluation of the switch positions.
